(19) United States
(12) Patent Application Publication
(10) Pub. No.: US 2025/0293236 A1
(43) Pub. Date: Sep. 18, 2025

(54) POSITIVE ELECTRODE FOR NON-AQUEOUS ELECTROLYTE SECONDARY BATTERY AND NON-AQUEOUS ELECTROLYTE SECONDARY BATTERY

(71) Applicant: THE FURUKAWA BATTERY CO., Ltd., Yokohama-shi (JP)

(72) Inventors: Yosuke MASUDA, Fukushima (JP); Miyu NEMOTO, Fukushima (JP)

(73) Assignee: THE FURUKAWA BATTERY CO., Ltd., Yokohama-shi (JP)

(21) Appl. No.: 18/963,153

(22) Filed: Nov. 27, 2024

(30) Foreign Application Priority Data
Mar. 18, 2024 (JP) 2024-042545

(51) Int. Cl. H01M 4/36; H01M 4/02; H01M 4/131; H01M 4/525; H01M 4/58; H01M 10/0568; H01M 10/0569

(52) U.S. Cl. CPC H01M 4/364; H01M 4/131; H01M 4/525; H01M 4/5825; H01M 10/0568; H01M 10/0569; H01M 2004/021; H01M 2004/028

(57) ABSTRACT

Provided is a positive electrode for a non-aqueous electrolyte secondary battery that includes a positive electrode current collector and a positive electrode mixture layer, and the positive electrode mixture layer contains a first positive electrode active material, a second positive electrode active material in which a coating film made of a carbon material is formed on a surface of a phosphate compound having an olivine structure, and an electrically conductive aid.

### CROSS-REFERENCE TO RELATED APPLICATION(S)

This application claims the benefit of priority from Japanese Patent Application No. 2024-042545 filed on Mar. 18, 2024, the entire contents of which are incorporated herein by reference.

### BACKGROUND

### 1. Technical Field

The present disclosure relates to a positive electrode for a non-aqueous electrolyte secondary battery and a non-aqueous electrolyte secondary battery.

### 2. Related Art

Non-aqueous electrolyte secondary batteries have been widely used for such reasons as a high energy density thereof and the like, and are mounted as power sources for portable small devices such as mobile phones, digital cameras, and notebook computers. Further, considering the problem of energy resource depletion, global warming, and the like, non-aqueous electrolyte secondary batteries have been increasingly developed to find large-scale industrial applications such as hybrid vehicles, electric vehicles, or power storage using natural energy power generation such as sunlight and wind power.

In recent years, a non-aqueous electrolyte secondary battery also has attracted attention as a motive power source for a drone, a robot, an electric vehicle, a hybrid electric vehicle, and the like, and is expected to expand its application. Such a motive power source is required to be much denser, and, as countermeasures therefor, a means of using of lithium nickelate (NCA) having a high unit capacity or using a high-Ni-containing NCM-based material mainly composed of nickel, cobalt, and manganese, as a positive electrode active material, or the like, has been adopted (see, for example, JP 2019-50105 A).

### SUMMARY

However, in a case in which a high-Ni-containing NCM-based material is used as a positive electrode active material, there is caused a peculiar problem of formation of a highly insulative substance on the surface of the positive electrode active material because a high-Ni-containing NCM-based positive electrode active material has low chemical stability and thus has high reactivity with an electrolytic solution, which would not be caused in other NCM-based positive electrode active materials. For this reason, use of high-Ni NCM-based material results in an increase of internal resistance during or after production of a cell, which is a large barrier to practical use.

The disclosure has been made in view of the above problems, and even with a positive electrode including a high-Ni-containing NCM-based positive electrode active material, it is desirable to provide a positive electrode for a non-aqueous electrolyte secondary battery that can suppress an increase of internal resistance, and a non-aqueous electrolyte secondary battery using the positive electrode.

In some embodiments, a positive electrode for a non-aqueous electrolyte secondary battery includes: a positive electrode current collector; and a positive electrode mixture layer formed on a surface of the positive electrode current collector. The positive electrode mixture layer contains: a first positive electrode active material that is a layered compound represented by a general formula shown in a formula (1) below:
LiₐNiₓCo_{y}M1_{1-x-y}O₂ (where 0<a≤1.2, 0.6≤x≤0.8, 0.1≤y≤0.2, 0.7≤x+y≤0.9) (1); a second positive electrode active material in which a coating film made of a carbon material is formed on a surface of a phosphate compound having an olivine structure, the phosphate compound being represented by a general formula shown in a formula (2) below:
LiMn_{z}M2_{b}Fe_{1-z-b}PO₄ (where 0<z≤0.9, 0≤b≤0.1, 0<z+b<1) (2); and an electrically conductive aid, and the positive electrode mixture layer satisfies a formula (3) below:
0.8≤(n×p)^{2/3}≤13 (3), where n is a theoretical minimum number of particles of the second positive electrode active material, and p is a ratio of a mass of the first positive electrode active material to a mass of the second positive electrode active material, in the formula (1), M1 is at least one kind selected from the group consisting of Ti, Zr, Nb, W, P, Al, Mg, V, Mn, Ca, Sr, Cr, Fe, B, Ga, In, Si, Mo, Y, Sn, Cu, Ag, Ce, Pr, Ge, Bi, Ba, Er, La, Sm, Yb, Sb, Bi, S, and Zn, and in the formula (2), M2 is at least one kind selected from the group consisting of Ni, Co, Ti, Cu, Zn, Mg, Zr, Ca, Y, Mo, Ba, Pb, Bi, La, Ce, Nd, Gd, Al, Ga, and Sr.

In some embodiments, a non-aqueous electrolyte secondary battery includes: the positive electrode for a non-aqueous electrolyte secondary battery; a negative electrode; a separator; and a non-aqueous electrolytic solution containing lithium salt and a non-aqueous solvent.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a sectional view for describing a configuration of a non-aqueous electrolyte secondary battery according to a first embodiment of the disclosure; and

FIG. 2 is an exploded perspective view for describing a configuration of a non-aqueous electrolyte secondary battery according to a second embodiment of the disclosure.

### DETAILED DESCRIPTION OF THE PREFERRED EMBODIMENTS

Hereinafter, embodiments of the disclosure will be described, but the disclosure is not limited to the following description. Further, various changes or improvements can be added to the present embodiments, and the disclosure can also include embodiments to which such changes or improvements are added.

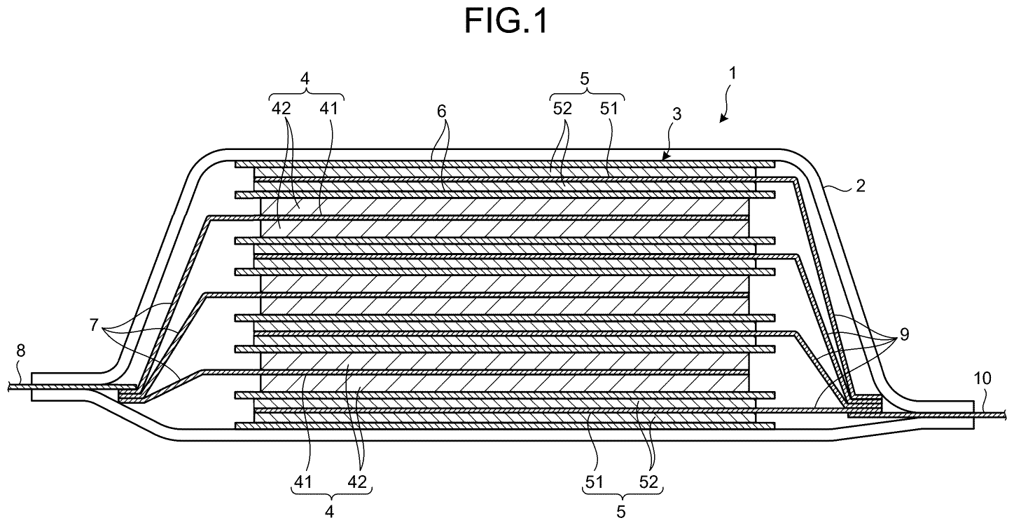

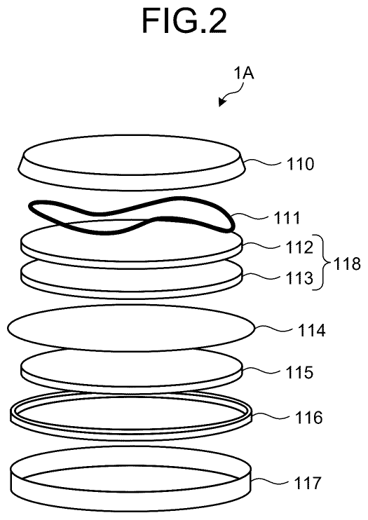

As will be later described in detail, FIG. 1 is a sectional view of a laminated non-aqueous electrolyte secondary battery, and FIG. 2 is an exploded perspective view for describing a configuration of a coin-shaped non-aqueous electrolyte secondary battery.

In FIG. 1 and FIG. 2, there are illustrated examples of configurations in the cases of a laminated non-aqueous electrolyte secondary battery and a coin-shaped non-aqueous electrolyte secondary battery, as examples of the embodiments, but a shape of a non-aqueous electrolyte secondary battery in the disclosure is not limited to any particular shape, and may be a flat shape, a cylindrical shape, a rectangular square, a coin shape, or the like. Further, an outer package of the non-aqueous electrolyte secondary battery is not limited to any particular material, and a known outer package such as a laminated film, aluminum, aluminum alloy, or stainless steel can be used.

### First Embodiment

FIG. 1 is a sectional view for describing a configuration of a non-aqueous electrolyte secondary battery according to a first embodiment of the disclosure. A non-aqueous electrolyte secondary battery 1 illustrated in FIG. 1 is a laminated non-aqueous electrolyte secondary battery in which a plurality of sets each including a positive electrode 4, a negative electrode 5, and a separator 6 are stacked.

The non-aqueous electrolyte secondary battery 1 includes a bag-shaped outer package 2 made of a laminated film. An electrode group 3 having a layered structure is housed in the outer package 2. The laminated film has a structure in which, for example, a plurality of (for example, two) plastic films are stacked, and metal foil such as aluminum foil is sandwiched between adjacent plastic films. For one of the two plastic films, a heat-sealable resin film is used. In the outer package 2, two laminated films are stacked such that the heat-sealable resin films face each other, the electrode group 3 and a non-aqueous electrolyte are housed between those laminated films, and portions of the two laminated films around the electrode group 3 are heat-sealed to each other to be sealed, thereby airtightly housing the electrode group 3 and the non-aqueous electrolyte.

The electrode group 3 includes the positive electrode 4, the negative electrode 5, the separator 6, positive electrode leads 7, a positive electrode tab 8, negative electrode leads 9, and a negative electrode tab 10. The separator 6 is interposed between the positive electrode 4 and the negative electrode 5. The electrode group 3 has a structure in which a plurality of layers are stacked such that the negative electrode 5 is positioned at the outermost layer and the separator 6 is positioned between the negative electrode 5 and an inner surface of the outer package 2. Further, it is preferred that the separator 6 be positioned between the negative electrode 5 and the inner surface of the outer package 2.

### Positive Electrode

The positive electrode 4 includes a positive electrode current collector 41 and a positive electrode mixture layer 42 formed on one surface or both surfaces of the positive electrode current collector 41.

The positive electrode current collector 41 is made of copper, aluminum, nickel, stainless steel, titanium, another alloy, or the like. Among them, aluminum is preferably used in terms of electron conductivity and a battery operating potential.

The positive electrode mixture layer 42 contains a positive electrode active material, an electrically conductive aid, and a binder.

The positive electrode active material includes a first positive electrode active material and a second positive electrode active material, and has a shape of a film that is formed by, for example, being applied to the positive electrode current collector 41 and dried. The positive electrode mixture layer 42 has a density that is adjusted by, for example, pressing.

The first and second positive electrode active materials can occlude and desorb lithium, respectively.

The first positive electrode active material is secondary particles of a layered compound represented by a general formula shown in the following formula (1), and is preferably secondary particles having a secondary particle size (D50) of 3 μm or more and 30 μm or less. The layered compound is lithium (Li)-cobalt (Co)-nickel (Ni)-containing composite metal oxide (hereinafter also referred to as NCM) in which sheet-like particles form layers. The secondary particle refers to a particle in which a plurality of single particles (primary particles) are aggregated to form an aggregate.

LiₐNiₓCo_{y}M1_{1-x-y}O₂(where 0<a≤1.2, 0.6≤x≤0.8, 0.1≤y≤0.2, 0.7≤x+y≤0.9) (1)

Here, in the above formula (1), M1 represents at least one kind selected from the group consisting of titanium (Ti), zirconium (Zr), niobium (Nb), tungsten (W), phosphorus (P), aluminum (Al), magnesium (Mg), vanadium (V), manganese (Mn), calcium (Ca), strontium (Sr), chromium (Cr), iron (Fe), boron (B), gallium (Ga), indium (In), silicon (Si), molybdenum (Mo), yttrium (Y), tin (Sn), copper (Cu), silver (Ag), cerium (Ce), praseodymium (Pr), germanium (Ge), bismuth (Bi), barium (Ba), erbium (Er), lanthanum (La), samarium (Sm), ytterbium (Yb), antimony (Sb), bismuth (Bi), sulfur (S), and zinc (Zn).

Note that D50 refers to a median diameter, and is a diameter value corresponding to a median value of a particle-size distribution.

Further, NCM containing 60% or more of Ni as used in the disclosure is referred to as a high-Ni-containing NCM-based positive electrode active material.

The second positive electrode active material is a phosphate compound (hereinafter also referred to as LMFP) that is represented by a general formula shown in the following formula (2) and that has an olivine structure.

LiMn_{z}M2_{b}Fe_{1-z-b}PO₄ (where 0<z≤0.9, 0≤b≤0.1, 0<z+b<1) (2)

Here, in the above formula (2), M2 represents at least one kind selected from the group consisting of Ni, Co, Ti, Cu, Zn, Mg, Zr, Ca, Y, Mo, Ba, Pb, Bi, La, Ce, Nd, Gd, Al, Ga, and Sr.

The second positive electrode active material is formed by, for example, formation of a coating film made of a carbon material on a surface of the phosphate compound (primary particles). The second positive electrode active material preferably has a particle size of 1 μm or more and 10 μm or less as a particle size (D50) of a secondary particle. Note that the second positive electrode active material, like the first positive electrode active material, may be, for example, an aggregate (secondary particle) formed by aggregation of a plurality of single particles (primary particles).

The respective substance-amount ratios of the metal elements in the first positive electrode active material and the second positive electrode active material and the elements contained as M1 and M2 may be the same or different as long as they fall within the above-described ranges.

It is required that a ratio of a weight of the second positive electrode active material to a total weight of the first positive electrode active material and the second positive electrode active material be 10% or higher and 20% or lower.

In this regard, when the ratio of the weight of the second positive electrode active material to the total weight of the first positive electrode active material and the second positive electrode active material is lower than 10%, an abundance ratio of the first positive electrode active material is high. Then, it is difficult to suppress an increase of internal resistance by covering the particles of the first positive electrode active material having low chemical stability and high reactivity with an electrolytic solution with the second positive electrode active material having high chemical stability and low reactivity with an electrolytic solution under a certain condition and thus reducing direct contact with the electrolytic solution. Meanwhile, when the ratio of the weight of the second positive electrode active material to the total weight of the first positive electrode active material and the second positive electrode active material is higher than 20%, the abundance ratio of the second positive electrode active material is high, which causes a concern about reduction of volume energy density. In order to suppress an increase of internal resistance, it is preferred that the ratio of the weight of the second positive electrode active material to the total weight of the first positive electrode active material and the second positive electrode active material be 15% or higher and 20% or lower.

In the first embodiment, the positive electrode mixture layer 42 contains the first positive electrode active material that is a layered compound, the second positive electrode active material in which a coating film made of a carbon material is formed on a surface of a phosphate compound having an olivine structure, and an electrically conductive aid, and the positive electrode mixture layer 42 satisfies the following formula (3).

$$0.8 \leq {( n \times p )}^{2 / 3} \leq 13 \qquad ( 3 )$$

In the formula, n is the theoretical minimum number of particles based on a ratio between the secondary particle size of the first positive electrode active material and the secondary particle size of the second positive electrode active material, and p is a ratio of the weight of the first positive electrode active material to the weight of the second positive electrode active material (the weight of the first positive electrode active material/the weight of the second positive electrode active material). Further, the secondary particle size in the above formula (3) is a measured value based on an SEM image.

Specifically, n is calculated by a formula represented by the following formula (4).

$$n = 4 \times {( {r}_{N} / {r}_{L} )}^{2} \qquad ( 4 )$$

In the formula, r_{N} is the secondary particle size of the first positive electrode active material, and r_{L} is the secondary particle size of the second positive electrode active material. Further, the secondary particle size in the above formula (4) is a measured value based on SEM image.

Here, p is preferably 4 or more and 9 or less. For example, when p=4, the weight mixture ratio of the first positive electrode active material to the second positive electrode active material is 20 wt %, and when p=9, the weight mixture ratio of the first positive electrode active material to the second positive electrode active material is 10 wt %.

In one example, when p=4 (the weight ratio of LMFP is 20 wt %), r_{N}/r_{L}≥2.16 is satisfied, so that the particles of the second positive electrode active material can geometrically surround the particles of the first positive electrode active material.

Here, a process of deriving the above formula (4) is as follows. In a state where the second positive electrode active material surrounds the first positive electrode active material and the first positive electrode active material is filled with the second positive electrode active material without any gap, a relationship of the following formula (5) is established.

$$4 π {r}_{N}^{2} \leq n \times π {r}_{L}^{2} \qquad ( 5 )$$

The above formula (4) is derived from the above formula (5).

Further, it is preferred that the above formula (3) satisfy the following formula (3)′ from the viewpoint of suppressing an increase of internal resistance.

$$0.8 \leq {( n \times p )}^{2 / 3} \leq 11 \qquad {( 3 )}^{′}$$

It is possible to check whether or not the above formula (3) (or (3)′) is satisfied by examining a section of the positive electrode mixture layer 42 in an EDS image obtained by energy dispersive X-ray spectroscopy (EDS). Note that this visual field is assumed in an electrode that can be checked three times, or twice or more in a case in which sectional views are randomly taken.

As a major premise, it has been a well-known fact that a compounding ratio of materials is important in considering the configuration of the positive electrode mixture layer, but analysis of what configuration and arrangement of the materials inside the mixture layer is important has not yet been achieved. The disclosure focuses on the configuration and arrangement. The reason why the effect is ascertained by the configuration of the disclosure is not clear, but it is assumed as follows.

In a case in which the same amount of active materials having different particle sizes are included, as the ratio of the secondary particle size of the first positive electrode active material to the secondary particle size of the second positive electrode active material increases, a proportion of the surface of the first positive electrode active material surrounded by the second positive electrode active material increases. It is a matter of course that, when the ratio of the secondary particle size of the first positive electrode active material to the secondary particle size of the second positive electrode active material is set to a certain value or more, a contact area with a carbon material (hereinafter also referred to as C) or the second positive electrode active material is large and contact with an electrolytic solution is small as compared to a case where the ratio is lower than the certain value. When the ratio is lower than the certain value, the surface of the first positive electrode active material cannot be sufficiently covered with the second positive electrode active material, which causes an increase of internal resistance. The present inventors have found that, under the condition satisfying the above formula (3), the surface of the first positive electrode active material can be sufficiently covered with the second positive electrode active material, and an effect of suppressing an increase of internal resistance can be expected.

When D50 representing the secondary particle size of the first positive electrode active material is 3 μm or more and 30 μm or less, and D50 representing the secondary particle size of the second positive electrode active material is 1 μm or more and 10 μm or less, the surface of the first positive electrode active material can be sufficiently covered with the second positive electrode active material, and an increase of internal resistance can be suppressed. For control of D50 representing the secondary particle size, a sieve that has a mesh size of about 1500 and is targeted for a size of 5 μm to 10 μm can be used.

In order to control the positive electrode mixture layer as described above, some contrivance to the ratio between the particle size of the first positive electrode active material and the particle size of the second positive electrode active material, as a first point, and to a mixing method during production of positive electrode mixture layer slurry, as a second point, is necessary. Specifically, the contrivance is made as follows.

In a process of producing positive electrode mixture slurry, first, the first positive electrode active material having a particle size of 10 μm, the second positive electrode active material, and the electrically conductive aid are mixed in a dry state. A solvent is added to the mixture such that the binder and a solid content are in a range from 80 to 85%, and is mixed with the mixture. The slurry at that time has no fluidity and is put into one bulk with no visible small lumps. After that, the viscosity is lowered to a viscosity at which coating can be performed (solid content: 75% to 70%) with a solvent. The mixing process is performed by, for example, a rotation-revolution mixer (Awatori Rentaro: manufactured by THINKY CORPORATION), but the apparatus may be changed as appropriate to, for example, a high-speed mixer including a stirring blade that can be rotationally driven in a stirring container. Hereinafter, in the present specification, a technique in which a mixing process in a dry state is performed first will be referred to as “thick kneading”, and a technique in which a mixing process in a wet state is performed first will be referred to as “liquid kneading”.

In terms of the energy density, the positive electrode mixture layer 42 has preferably a density of 2.3 g/cm³ or higher, and more preferably a density of 2.5 g/cm³ or higher. Further, in order to secure an appropriate gap in the positive electrode mixture layer 42 to keep an excellent electrolyte impregnation property and obtain excellent cyclic characteristics, the density is preferably 3.5 g/cm³ or lower, and more preferably 2.9 g/cm³ or lower.

The positive electrode mixture layer 42 is applied to one surface or both surfaces of the positive electrode current collector 41, and the application amount per one surface is preferably 75 g/m² or more and 200 g/m² or less. By setting the application amount of the positive electrode mixture layer 42 to a value in the above-described range, it is possible to secure a sufficient energy density and to keep excellent output characteristics and excellent cycling characteristics. Moreover, in order to form the positive electrode lead 7, it is preferred to leave a region not coated with the positive electrode mixture layer 42 on the positive electrode current collector 41.

Meanwhile, in the present specification, the secondary particle size D50 represents a particle size of each particle obtained using a laser diffraction particle-size distribution measuring apparatus. The secondary particle size D50 indicates that a relative particle amount measured by the laser diffraction/scattering method described in JIS Z8825:2013 is 50%. The measured value of the secondary particle size represents an average value of particle sizes obtained using a scanning electron microscope (SEM). For example, 20 particles that can be recognized in an SEM image are randomly selected, and an average value of the major diameters thereof can be employed, and the same value is used in examples and comparative examples. Note that, in the examples, the secondary particle size D50 of the first positive electrode active material was substantially equal to the measured value of the secondary particle size of the first positive electrode active material.

Further, it is possible to check whether the particle sizes and mixture ratios of the first positive electrode active material and the second positive electrode active material in the produced positive electrode mixture layer satisfy the requirements of the disclosure by the following method. The non-aqueous electrolyte secondary battery is disassembled in a glove box filled with an inert gas such as argon, and the positive electrode 4 is taken out. The positive electrode 4 is washed with an appropriate non-aqueous organic solvent (such as dimethyl carbonate, for example) and then dried to remove the solvent. Subsequently, the positive electrode 4 is immersed in a solvent such as N-methyl-2 pyrrolidone, and ultrasonic waves are applied thereto, whereby the positive electrode mixture layer 42 can be taken out from the positive electrode current collector 41. The solvent in which the separated positive electrode mixture layer 42 is dispersed is subjected to centrifugal separation, and thus each substance in the positive electrode mixture layer 42 can be separated. Specifically, for the first positive electrode active material, a volume-based particle-size distribution is measured using a laser diffraction particle-size distribution measuring apparatus, and thus the particle size and mixture ratio of each active material contained in the positive electrode mixture layer 42 can be measured. As the laser diffraction particle-size distribution measuring apparatus, SALD-2300 (manufactured by SHIMADZU CORPORATION) or the like can be used. A coating film density can be measured using the positive electrode 4 having been washed. The positive electrode 4 is punched out using a puncher capable of punching a randomly-selected area. Then, the weight of the punched positive electrode 4 is measured using an electronic balance or the like, and the thickness of the punched positive electrode 4 is measured using a micrometer, a film thickness meter, or the like, so that the weight and thickness can be checked. A coating weight can be checked from the weight of the electrode of the positive electrode 4 having been punched out at the time of measuring the coating film density, and the area thereof. Note that the non-aqueous electrolyte secondary battery used as above may be subjected to initial activation or a charging/discharging cycle in a randomly-selected step, and, in taking out the positive electrode 4, it is preferred that the battery be completely discharged to a lower-limit voltage estimated by a manufacturer in advance. Further, there is no large difference in density between the positive electrode before being assembled into the non-aqueous electrolyte secondary battery and the positive electrode completely discharged to a lower-limit voltage of the non-aqueous electrolyte secondary battery.

The electrically conductive aid assists in electrically conduction of electrons in the positive electrode. The electrically conductive aid is not limited to any particular material, and known electrically conductive aids can be used. Examples of the electrically conductive aid include electrically conductive carbon powders such as carbon black such as acetylene black and Ketjen black, carbon nanotubes, carbon nanofibers, graphene, activated carbon, and graphite. The electrically conductive aid may be made of one kind of material, or may be made of a plurality of kinds of materials (for example, a first electrically conductive aid and a second electrically conductive aid).

A weight ratio of the electrically conductive aid to the positive electrode mixture layer is preferably 0.5% or higher and 10% or lower. When the weight ratio is lower than 0.5%, it is insufficient to form an electrically conductive path, and when the weight ratio is higher than 10%, a relative amount of the active material in the positive electrode mixture layer is insufficient.

The binder binds the positive electrode current collector, the positive electrode active material, and the electrically conductive aid. The binder is not limited to any particular material, and known binders or commercially-available binders can be used. Examples of the binder include polyvinylidene difluoride (PVDF), polytetrafluoroethylene (PTFE), polyvinylpyrrolidone (PVP), polyvinyl chloride (PVC), polyethylene (PE), polypropylene (PP), ethylene-propylene copolymer, styrene-butadiene rubber (SBR), butadiene rubber, polyvinyl alcohol (PVA), carboxymethyl cellulose (CMC), butyl rubber, polymethyl methacrylate (PMMA), polyethylene oxide (PEO), polypropylene oxide (PO), polyepichlorohydrin, polyphosphazene, polyacrylonitrile, and the like.

### Negative Electrode

The negative electrode 5 includes a negative electrode current collector 51 and a negative electrode mixture layer 52 containing a negative electrode active material formed on one surface or both surfaces of the negative electrode current collector 51. Note that the negative electrode 5 may be made of metal lithium.

The negative electrode current collector 51 is not limited to any particular material, but metal is preferably used. For the metal, for example, aluminum foil or copper is suitable, and a porous aluminum current collector or the like is also used depending on the application. Among them, copper is preferably used in terms of electron conductivity and a battery operating potential.

The negative electrode mixture layer 52 contains, for example, at least one kind selected from the group consisting of lithium alloy, titanium-niobium alloy, graphite, amorphous carbon, a transition metal composite oxide (for example, Li₄Ti₅O₁₂, TiNb₂O₇, or the like), alloy capable of occluding and emitting lithium, and silicon, as an active material. Among them, graphite is preferable because it has an operating potential extremely close to that of metal lithium and thus can be charged and discharged at a high operating voltage, and also because it has excellent cycling characteristics. Meanwhile, a combination of graphite and another negative electrode active material may be used.

Further, the negative electrode mixture layer 52 may contain a binder and an electrically conductive aid. As the binder and the electrically conductive aid, materials similar to the materials used in the positive electrode 4 can be used.

The negative electrode mixture layer 52 is preferably applied to one surface or both surfaces of the negative electrode current collector 51. An application amount per one surface is preferably 40 g/m² or more and 120 g/m² or less. By setting the application amount of the negative electrode mixture layer 52 to a value in the above-described range, it is possible to secure a sufficient energy density and to keep excellent output characteristics and excellent cycling characteristics. Further, from the viewpoint of suppressing precipitation of lithium metal dendrite during charging, the application amount of the negative electrode mixture layer 52 is preferably set such that the negative electrode-to-positive electrode capacity ratio is 1.01 or higher, and more preferably 1.1 or higher.

Here, the negative electrode-to-positive electrode capacity ratio is calculated by the following formula (6).

(Negative electrode-to-positive electrode capacity ratio)=(negative electrode capacity of one surface per area)/(Positive electrode capacity of one surface per area) (6)

In this regard, when the negative electrode-to-positive electrode capacity ratio is too high, an amount of the negative electrode mixture layer 52 that does not contribute to charging/discharging reaction increases, and the energy density decreases. Therefore, the value of the negative electrode-to-positive electrode capacity ratio is preferably 1.3 or lower, and more preferably 1.2 or lower.

In terms of the energy density, the negative electrode mixture layer 52 has preferably a density of 1.0 g/cm³ or higher, and more preferably a density of 1.2 g/cm³ or higher. Further, in order to secure an appropriate gap in the negative electrode mixture layer 52 to keep an excellent electrolyte impregnation property and obtain excellent cyclic characteristics, the density of the negative electrode mixture layer 52 is preferably 1.7 g/cm³ or lower, and more preferably 1.5 g/cm³ or lower.

### Separator

The separator 6 is provided between the positive electrode 4 and the negative electrode 5, and has porosity high enough to allow a non-aqueous electrolyte component to pass therethrough. The separator 6 is formed using, for example, a separator of a porous sheet made of a polymer or a fiber, a nonwoven fabric separator, or the like. The separator 6 may be made of a material including polyethylene, polypropylene, aramid, polyimide, or the like, or may include a plurality of layers of different materials including those materials, but preferably has a layer including polyethylene from the viewpoint of imparting a shutdown function at the time of heat generation. The separator 6 has preferably a pore size of 0.01 to 10 μm and a thickness of 5 to 30 μm. Further, the separator 6 may be formed of a ceramic layer as a heat-resistant insulating layer stacked on a porous substrate. In a case in which a solid electrolyte is used as the non-aqueous electrolyte, the separator 6 may be omitted.

### Others

The positive electrode leads 7 extend, for example, to the lower side of the positive electrode mixture layer 42 in FIG. 1. In one example, each positive electrode lead 7 is a portion to which the positive electrode mixture layer 42 is not applied in the positive electrode current collector 41. The positive electrode leads 7 are tied together and joined to each other at an end portion on a side opposite to the positive electrode mixture layer 42 in the outer package 2.

The positive electrode tab 8 has one end joined to the positive electrode lead 7 and has the other end extending to the outside through the sealed portion of the outer package 2.

The negative electrode leads 9 extend, for example, to the upper side of the negative electrode mixture layer 52 in FIG. 1. The negative electrode leads 9 may extend in the same direction as the positive electrode leads 7 as long as the negative electrode leads 9 do not come into contact with the positive electrode leads 7. In one example, each negative electrode lead 9 is a portion to which the negative electrode mixture layer 52 is not applied in the negative electrode current collector 51. The negative electrode leads 9 are tied together and joined to each other at an end portion on a side opposite to the negative electrode mixture layer 52 in the outer package 2.

The negative electrode tab 10 has one end joined to the negative electrode lead 9 and has the other end extending to the outside through the sealed portion of the outer package 2.

### Non-Aqueous Electrolyte

As the non-aqueous electrolyte, a non-aqueous electrolytic solution or a solid electrolyte can be used. Here, specifically, a non-aqueous electrolytic solution that is a liquid will be described. A non-aqueous electrolytic solution is enclosed in the outer package 2. A spot where the non-aqueous electrolytic solution is to be injected in the outer package 2 is sealed after the non-aqueous electrolytic solution is injected. The non-aqueous electrolytic solution contains an electrolyte and a non-aqueous solvent.

The electrolyte is not limited to any particular material, and lithium salt generally used in a non-aqueous electrolyte secondary battery can be used. For example, LiPF₆, LiAsF₆, LiBF₄, LiCF₃SO₃, LiN (CₘF₂ₘ₊₁SO₂) (CₙF₂ₙ₊₁SO₂) (m and n are integers of one or more), LiC (CₛF₂ₛ₊₁SO₂) (CₜF₂ₜ₊₁SO₂) (CᵤF₂ᵤ₊₁SO₂) (s, t, and u are integers of one or more), lithium difluoro (oxalato) borate, and the like can be used. Those electrolytes may be used singly or in combination of two or more kinds thereof. In addition, it is desired that the electrolyte has a concentration of 0.1 to 3 mol/L, preferably 0.5 to 1.5 mol/L in terms of lithium ion conductivity, viscosity of the electrolytic solution, temperature characteristics of conductivity, and the like.

The non-aqueous solvent contains cyclic carbonate and/or chain carbonate as a main component. The cyclic carbonate is preferably at least one selected from the group consisting of ethylene carbonate (EC), propylene carbonate (PC), and butylene carbonate (BC). The cyclic carbonate is preferably at least one selected from the group consisting of dimethyl carbonate (DMC), diethyl carbonate (DEC), and ethyl methyl carbonate (EMC). The cyclic carbonate is related to the degree of dissociation of an electrolyte component, and the chain carbonate is related to the viscosity of an electrolytic solution.

Note that, in the disclosure, DMC is the most suitable. It is generally known that addition of DMC reduces the viscosity of an electrolytic solution. It is also known that, due to reduction in the viscosity, the permeability of an electrolytic solution into an electrode is improved and thus the overall battery performance tends to be improved, but the present inventors have found that the tendency is weakened in a high-Ni-containing NCM-based positive electrode active material. The high-Ni-containing NCM-based positive electrode active material used in the disclosure has low chemical stability, resulting in generation of a substance having high reactivity with an electrolytic solution and a high insulating property. The present inventors have found that the performance is further deteriorated by direct contact between the high-Ni-containing NCM-based positive electrode active material and DMC, and the performance of DMC and the high-Ni-containing NCM-based positive electrode active material can be sufficiently exploited by adjustment of the configuration in connection with LMFP as in the disclosure.

Further, the non-aqueous electrolyte may contain an additive other than lithium salt described above for the purpose of forming a high-quality coating film on the surface of the negative electrode active material by reductive decomposition during charging and discharging. The additive is not limited to any particular material, and examples thereof include vinylene carbonate (VC), fluoroethylene carbonate, 1,3,2-dioxathiolane 2,2-dioxide (MMDS), 1,5,2,4-dioxadithiane 2,2,4,4-tetraoxide, tris (trimethylsilyl) phosphite, 1-propene 1,3-sultone, and Li₂PO₂F₂. Those additives may be used singly or in combination of two or more. Further, the additive may be used in combination with an additive other than those. Moreover, an additive other than those may be used singly. However, adding those additives in an excessive amount easily involves generation of gas during high-temperature cycles, which causes reduction in capacity. Thus, for example, a ratio of each additive to the weight of the entire non-aqueous electrolytic solution is preferably set to 3% or lower, and more preferably 1% or lower. Further, in use of those additives, it is always necessary to use those additives together with VC from the viewpoint of suppressing gas generation.

In the first embodiment, in the positive electrode 4 of the non-aqueous electrolyte secondary battery 1, the positive electrode mixture layer 42 contains the first positive electrode active material that is a layered compound, the second positive electrode active material in which a coating film made of a carbon material is formed on a surface of a phosphate compound having an olivine structure, and the electrically conductive aid, and the positive electrode mixture layer 42 satisfies the formula (3) represented by 0.8≤(n×p)^{2/3}≤13, to thereby suppress an increase of internal resistance in the non-aqueous electrolyte secondary battery 1. According to the first embodiment, even with a positive electrode including a high-Ni-containing NCM-based positive electrode active material, it is possible to obtain a positive electrode for a non-aqueous electrolyte secondary battery that can suppress an increase of internal resistance by satisfying the condition represented by the above formula (3).

### Second Embodiment

FIG. 2 is an exploded perspective view for describing a configuration of a non-aqueous electrolyte secondary battery according to a second embodiment of the disclosure. A non-aqueous electrolyte secondary battery 1A includes a case 110, a leaf spring 111, a positive electrode current collector 112, a positive electrode mixture layer 113, a separator 114, a negative electrode 115, a gasket 116, and a cap 117. The positive electrode current collector 112 and the positive electrode mixture layer 113 form a positive electrode 118.

The non-aqueous electrolyte secondary battery 1A, in which the case 110 and the cap 117 are fixed by caulking or the like, is filled with a non-aqueous electrolyte. The non-aqueous electrolyte secondary battery 1A is liquid-tightly sealed by the case 110, the gasket 116, and the cap 117. Further, the positive electrode current collector 112, the positive electrode mixture layer 113, the separator 114, and the negative electrode 115 are biased toward the cap 117 by the leaf spring 111. As a result, the respective components are kept in close contact with each other.

The positive electrode current collector 112 is made of the same material as the positive electrode current collector 41.

The positive electrode mixture layer 113 has the same configuration as the positive electrode mixture layer 42.

The positive electrode current collector 112 and the positive electrode mixture layer 113 form a positive electrode 118.

The separator 114 is provided between the positive electrode and a negative electrode 115 and has a porous disk shape. The separator 114 has the same configuration as the separator 6.

As the non-aqueous electrolyte, the non-aqueous electrolyte in the first embodiment can be used.

The negative electrode 115 has the same configuration as the negative electrode 5.

In the second embodiment, as in the first embodiment, in the positive electrode 118 of the non-aqueous electrolyte secondary battery 1A, the positive electrode mixture layer 113 contains the first positive electrode active material that is a layered compound, the second positive electrode active material in which a coating film made of a carbon material is formed on a surface of a phosphate compound having an olivine structure, and the electrically conductive aid, and satisfies the above formula (3), to thereby suppress an increase of internal resistance in the non-aqueous electrolyte secondary battery 1A. According to the second embodiment, even with a positive electrode including a high-Ni-containing NCM-based positive electrode active material, it is possible to obtain a non-aqueous electrolyte secondary battery that can suppress an increase of internal resistance by satisfying the condition represented by the above formula (3).

### EXAMPLES

Below, the disclosure will be described in more detail with reference to examples, but the disclosure is not limited by the following examples in any way.

### Example 1

### Positive Electrode Producing Method

As the first positive electrode active material, Li_{1.1}Co_{0.1}Ni_{0.8}Mn_{0.1}O₂ that was NCM and had a secondary particle size D50 of 3.0 μm was used, and as the second positive electrode active material, LiMn_{0.6}Fe_{0.4}PO₄ that was LMFP and had a secondary particle size D50 of 6.7 μm was used. Carbon nanotubes (CNT) as the electrically conductive aid and N-methyl 2-pyrrolidone (M4P) as the binder and a viscosity adjustment solvent in appropriate amounts were mixed with the first and second positive electrode active materials, and liquid kneading was performed to prepare positive electrode active material slurry. Note that a weight ratio in the positive electrode active material slurry was set to (NCM+LMFP):CNT:binder=97.3:0.7:2. Meanwhile, Li_{1.1}Co_{0.1}Ni_{0.8}Mn_{0.1}O₂ is generally called NCM811.

The obtained positive electrode active material slurry was applied onto both surfaces of a positive electrode current collector and dried to form a positive electrode mixture layer, thereby producing a positive electrode.

### Negative Electrode Producing Method

Negative electrode slurry was prepared in which 96.7 wt % of graphite as the negative electrode active material, 0.3 wt % of acetylene black as the electrically conductive aid, 1.5 wt % of styrene-butadiene rubber as the binder, 1.5 wt % of carboxymethyl cellulose as a thickener, and an appropriate amount of ion-exchanged water as a viscosity adjustment solvent were mixed.

The prepared negative electrode active material slurry was applied onto both surfaces of a negative electrode current collector and dried to form a negative electrode mixture layer, thereby producing a negative electrode.

Preparation of non-aqueous electrolytic solution A solution in which 1.3 mol/L of LiPF₆ as lithium salt and 3 wt % of vinylene carbonate as an additive were dissolved in a mixed solvent obtained by mixing of ethylene carbonate, ethyl methyl carbonate and dimethyl carbonate at a volume ratio of 2:5:3 was used as the non-aqueous electrolytic solution.

### Production of Non-Aqueous Electrolyte Secondary Battery

The produced electrode was pressed so that the electrode had a predetermined coating film density, using a tabletop roll press machine of which setting gap was set to a randomly-selected value.

As the outer package, two laminated films having a structure in which heat-sealable resin layers made of polyolefin, metal layers made of aluminum foil, and protective layers made of nylon resin and polyester resin were stacked in the stated order were prepared. The heat-sealable resin layers of the two laminated films were placed so as to face each other, and superposed so as to allow the bonded surfaces of the laminated films to overlap each other so that an electrode group was housed in two housing recesses. The electrode group was placed such that a portion of each terminal corresponding to a heat-sealable resin portion passed between the outer edges of the two laminated films, and a part of each terminal was exposed to the outside. In this state, at three sides including two sides where each tab of the laminated films extended, the heat-sealable resin layers in the outer edges of the laminated films were heat-sealed. Subsequently, the electrolytic solution prepared as described above was injected from one side of the outer package not heat-sealed. Then, in a reduced pressure environment, the remaining one side of the outer package was heat-sealed, thereby producing a non-aqueous electrolyte secondary battery (cell).

### Measurement of Secondary Particle Size

D50 of the secondary particles of NCM and LMFP was checked in a sectional SEM image of the positive electrode mixture layer. Here, a method of acquiring an image of an assumed visual field is as follows. A type of an electron microscope was a scanning electron microscope (SEM), and conditions for acquiring an electron microscope image were that an image to be acquired was a secondary electron image, an acceleration voltage was 15 kV, a magnification was a 2500-fold magnification for a particle, and an applied current was P.C. 30 to P.C. 70. Then, the electrode surface having been coated and pressed was observed. In addition, elemental analysis was performed using an energy dispersive X-ray analyzer (EDS). By the elemental analysis, NCM and LMFP can be distinguished from each other.

Cells were produced using positive electrodes including NCM and LMFP at mass ratios shown in Tables 2A and 2B as positive electrode mixture layers. After a solution was injected and a CS process generally called chemical conversion treatment was performed, the cell was left at rest for 48 hours, and then alternating current resistance (ACR) was measured using a resistance meter manufactured by HIOKI E.E. CORPORATION. In the present specification, a custom-made item was used, but RM3544 is also commonly expected to be suitable. Table 1 is a process chart of charging and discharging during production of a battery. In the CS process, as shown in Table 1, charging and discharging were performed at a charging/discharging rate of 0.2 C from the second cycle to the fifth cycle. After the battery was disassembled, the positive electrode was washed with DMC, and the secondary particle size was checked in a sectional SEM image of the positive electrode mixture layer. The composition and physical properties in example 1 are shown in Tables 2A and 2B. Note that, in Table 2B, (r_{N}/r_{L}) represents a ratio between measured values of the secondary particle sizes. Further, in the table, the unit of the particle size is μm, and the ratio is the weight ratio (%).

TABLE 1

| Total number of | | | |
|---|---|---|---|
| cycles | Mode | Charging/Discharging | Rate |
| 1 | First time | Charging | 0.1 C |
| | | Discharging | 0.1 C |
| 2 to 5 | CS process | Charging | 0.2 C |
| | | Discharging | 0.2 C |

TABLE 2A

| | | NCM | | LMFP | | Amount of | |
|---|---|---|---|---|---|---|---|
| | NCM | particle | NCM | measured | LMFP | condition | Kneading |
| Level | kind | size | ratio | value | ratio | aid | method |
| Example 1 | 811 | 3.0 | 0.9 | 3.62 | 0.1 | 0.7 | Thick |
| | | | | | | | kneading |
| Example 2 | 811 | 3.0 | 0.9 | 6.37 | 0.1 | 0.7 | Thick |
| | | | | | | | kneading |
| Example 3 | 811 | 3.0 | 0.8 | 2.87 | 0.2 | 0.7 | Thick |
| | | | | | | | kneading |
| Example 4 | 811 | 3.0 | 0.8 | 6.45 | 0.2 | 0.7 | Thick |
| | | | | | | | kneading |
| Example 5 | 811 | 3.0 | 0.6 | 3.55 | 0.4 | 0.7 | Thick |
| | | | | | | | kneading |
| Example 6 | 622 | 10.6 | 0.6 | 5.05 | 0.4 | 0.7 | Thick |
| | | | | | | | kneading |
| Example 7 | 811 | 10.6 | 0.6 | 5.14 | 0.4 | 0.7 | Thick |
| | | | | | | | kneading |
| Example 8 | 811 | 3.0 | 0.6 | 5.57 | 0.4 | 0.7 | Thick |
| | | | | | | | kneading |
| Example 9 | 811 | 13.0 | 0.6 | 5.83 | 0.4 | 0.7 | Thick |
| | | | | | | | kneading |
| Example 10 | 811 | 10.6 | 0.6 | 5.09 | 0.4 | 0.5 | Thick |
| | | | | | | | kneading |
| Example 11 | 811 | 10.6 | 0.6 | 4.89 | 0.4 | 10.0 | Thick |
| | | | | | | | kneading |

TABLE 2B

| Level | rN/rL | p | n | (n × p)\hat{ }(2/3) | ACR (mΩ) |
|---|---|---|---|---|---|
| Example 1 | 0.828729282 | 9.0 | 2.747169 | 8.48695526 | 25.7 |
| Example 2 | 0.470957614 | 9.0 | 0.887204 | 3.994944624 | 25.6 |
| Example 3 | 1.045296167 | 4.0 | 4.370576 | 6.735954306 | 25.3 |
| Example 4 | 0.465116279 | 4.0 | 0.865333 | 2.288207344 | 25.5 |
| Example 5 | 0.845070423 | 1.5 | 2.856576 | 2.6381007 | 25.4 |
| Example 6 | 2.099009901 | 1.5 | 17.623370 | 8.874014822 | 22.3 |
| Example 7 | 2.062256809 | 1.5 | 17.011613 | 8.667446346 | 24.6 |
| Example 8 | 0.538599641 | 1.5 | 1.160358 | 1.446956848 | 25.2 |
| Example 9 | 2.229845626 | 1.5 | 19.888846 | 9.61908798 | 24.6 |
| Example 10 | 2.082514735 | 1.5 | 17.34747 | 8.781154347 | 20.3 |
| Example 11 | 2.167689162 | 1.5 | 18.79551 | 9.263252631 | 25.1 |

### Examples 2 to 11

In examples 2 to 11, positive electrodes including NCM and having proportions (ratios) p, the theoretical minimum numbers of particles n, and (n×p)^{2/3} as shown in Tables 2A and 2B were used. Specifically, in examples 3 and 5, the secondary particle size D50 of LMFP was 6.7 μm, and, in examples 2, 4, 6, 7, 8, and 9, the secondary particle size D50 of LMFP was 9.1 μm. In examples 10 and 11, the ratio of the electrically conductive aid was changed. The compositions and physical properties in examples 2 to 11 are shown in Tables 2A and 2B.

### Comparative Examples 1 to 42

In comparative examples 1 to 42, positive electrodes including NCM and having proportions (ratios) p, the theoretical minimum numbers of particles n, and (n×p)^{2/3} as shown in Tables 2A and 2B were used. Specifically, in comparative examples 1, 2, 3, 4, 15, 16, 17, 18, 29, 30, 31, and 32, the secondary particle size D50 of LMFP was 1.0 μm, in comparative examples 5, 6, 7, 8, 19, 20, 21, 22, 33, 34, 35, 36, and 37, the secondary particle size D50 of LMFP was 1.9 μm, in comparative examples 9, 10, 11, 23, 24, 25, 38, 39, and 40, the secondary particle size D50 of LMFP was 6.7 μm, and in comparative examples 12, 13, 14, 26, 27, 28, and 41, the secondary particle size D50 of LMFP was 9.1 μm. The compositions and physical properties in comparative examples 1 to 42 are shown in Tables 3A, 3B, 4A, and 4B.

TABLE 3A

| | | NCM | | LMFP | | Amount of | |
|---|---|---|---|---|---|---|---|
| | NCM | particle | NCM | measured | LMFP | condition | Kneading |
| Level | kind | size | ratio | value | ratio | aid | method |
| Comparative | 811 | 10.6 | 0.9 | 0.36 | 0.1 | 0.7 | Thick |
| example 1 | | | | | | | kneading |
| Comparative | 811 | 3.0 | 0.9 | 0.4 | 0.1 | 0.7 | Thick |
| example 2 | | | | | | | kneading |
| Comparative | 811 | 30.0 | 0.9 | 0.48 | 0.1 | 0.7 | Thick |
| example 3 | | | | | | | kneading |
| Comparative | 811 | 13.0 | 0.9 | 0.5 | 0.1 | 0.7 | Thick |
| example 4 | | | | | | | kneading |
| Comparative | 811 | 3.0 | 0.9 | 0.76 | 0.1 | 0.7 | Thick |
| example 5 | | | | | | | kneading |
| Comparative | 811 | 10.6 | 0.9 | 0.77 | 0.1 | 0.7 | Thick |
| example 6 | | | | | | | kneading |
| Comparative | 811 | 30.0 | 0.9 | 0.86 | 0.1 | 0.7 | Thick |
| example 7 | | | | | | | kneading |
| Comparative | 811 | 13.0 | 0.9 | 0.98 | 0.1 | 0.7 | Thick |
| example 8 | | | | | | | kneading |
| Comparative | 811 | 30.0 | 0.9 | 2.82 | 0.1 | 0.7 | Thick |
| example 9 | | | | | | | kneading |
| Comparative | 811 | 13.0 | 0.9 | 2.98 | 0.1 | 0.7 | Thick |
| example 10 | | | | | | | kneading |
| Comparative | 811 | 10.6 | 0.9 | 3.84 | 0.1 | 0.7 | Thick |
| example 11 | | | | | | | kneading |
| Comparative | 811 | 13.0 | 0.9 | 4.72 | 0.1 | 0.7 | Thick |
| example 12 | | | | | | | kneading |
| Comparative | 811 | 10.6 | 0.9 | 5.35 | 0.1 | 0.7 | Thick |
| example 13 | | | | | | | kneading |
| Comparative | 811 | 30.0 | 0.9 | 5.96 | 0.1 | 0.7 | Thick |
| example 14 | | | | | | | kneading |
| Comparative | 811 | 3.0 | 0.8 | 0.39 | 0.2 | 0.7 | Thick |
| example 15 | | | | | | | kneading |
| Comparative | 811 | 13.0 | 0.8 | 0.4 | 0.2 | 0.7 | Thick |
| example 16 | | | | | | | kneading |
| Comparative | 811 | 10.6 | 0.8 | 0.43 | 0.2 | 0.7 | Thick |
| example 17 | | | | | | | kneading |
| Comparative | 811 | 30.0 | 0.8 | 0.45 | 0.2 | 0.7 | Thick |
| example 18 | | | | | | | kneading |
| Comparative | 811 | 30.0 | 0.8 | 0.71 | 0.2 | 0.7 | Thick |
| example 19 | | | | | | | kneading |
| Comparative | 811 | 3.0 | 0.8 | 0.75 | 0.2 | 0.7 | Thick |
| example 20 | | | | | | | kneading |
| Comparative | 811 | 10.6 | 0.8 | 0.75 | 0.2 | 0.7 | Thick |
| example 21 | | | | | | | kneading |

TABLE 3B

| Level | rN/rL | p | n | (n × p)\hat{ }(2/3) | ACR (mΩ) |
|---|---|---|---|---|---|
| Comparative | 29.444444444 | 9.0 | 3467.901235 | 991.3023898 | 30.8 |
| example 1 | | | | | |
| Comparative | 7.500000000 | 9.0 | 225.000000 | 160.0601987 | 29.5 |
| example 2 | | | | | |
| Comparative | 62.500000000 | 9.0 | 15625.000000 | 2704.217944 | 30.7 |
| example 3 | | | | | |
| Comparative | 26.000000000 | 9.0 | 2704.000000 | 839.7811675 | 30.3 |
| example 4 | | | | | |
| Comparative | 3.947368421 | 9.0 | 62.326870 | 2 | 28.2 |
| example 5 | | | | | |
| Comparative | 13.766233766 | 9.0 | 758.036768 | 359.7122163 | 26.9 |
| example 6 | | | | | |
| Comparative | 34.883720930 | 9.0 | 4867.495944 | 1242.697444 | 30.1 |
| example 7 | | | | | |
| Comparative | 13.265306122 | 9.0 | 703.873386 | 342.3665838 | 26.6 |
| example 8 | | | | | |
| Comparative | 10.638297872 | 9.0 | 452.693526 | 255.0926012 | 29.6 |
| example 9 | | | | | |
| Comparative | 4.362416107 | 9.0 | 76.122697 | 77.71492845 | 27.0 |
| example 10 | | | | | |
| Comparative | 2.760416667 | 9.0 | 30.479601 | 42.21834343 | 31.1 |
| example 11 | | | | | |
| Comparative | 2.754237288 | 9.0 | 30.343292 | 42.09237899 | 31.5 |
| example 12 | | | | | |
| Comparative | 1.981308411 | 9.0 | 15.702332 | 27.13133173 | 31.3 |
| example 13 | | | | | |
| Comparative | 5.033557047 | 9.0 | 101.346786 | 94.05206323 | 28.5 |
| example 14 | | | | | |
| Comparative | 7.692307692 | 4.0 | 236.686391 | 96.41742278 | 29.1 |
| example 15 | | | | | |
| Comparative | 32.500000000 | 4.0 | 4225.000000 | 658.5536125 | 30.4 |
| example 16 | | | | | |
| Comparative | 24.651162791 | 4.0 | 2430.719308 | 455.5435145 | 30.4 |
| example 17 | | | | | |
| Comparative | 66.666666667 | 4.0 | 17777.777778 | 1716.425573 | 30.5 |
| example 18 | | | | | |
| Comparative | 42.253521127 | 4.0 | 7141.440190 | 934.4667717 | 30.5 |
| example 19 | | | | | |
| Comparative | 4.000000000 | 4.0 | 64.000000 | 40.3174736 | 27.6 |
| example 20 | | | | | |
| Comparative | 14.133333333 | 4.0 | 799.004444 | 216.973215 | 27.1 |
| example 21 | | | | | |

TABLE 4A

| | | NCM | | LMFP | | Amount of | |
|---|---|---|---|---|---|---|---|
| | NCM | particle | NCM | measured | LMFP | condition | Kneading |
| Level | kind | size | ratio | value | ratio | aid | method |
| Comparative | 811 | 13.0 | 0.8 | 0.98 | 0.2 | 0.7 | Thick |
| example 22 | | | | | | | kneading |
| Comparative | 811 | 10.6 | 0.8 | 3.36 | 0.2 | 0.7 | Thick |
| example 23 | | | | | | | kneading |
| Comparative | 811 | 30.0 | 0.8 | 3.4 | 0.2 | 0.7 | Thick |
| example 24 | | | | | | | kneading |
| Comparative | 811 | 13.0 | 0.8 | 3.65 | 0.2 | 0.7 | Thick |
| example 25 | | | | | | | kneading |
| Comparative | 811 | 10.6 | 0.8 | 5.98 | 0.2 | 0.7 | Thick |
| example 26 | | | | | | | kneading |
| Comparative | 811 | 30.0 | 0.8 | 6.28 | 0.2 | 0.7 | Thick |
| example 27 | | | | | | | kneading |
| Comparative | 811 | 13.0 | 0.8 | 6.57 | 0.2 | 0.7 | Thick |
| example 28 | | | | | | | kneading |
| Comparative | 811 | 13.0 | 0.6 | 0.43 | 0.4 | 0.7 | Thick |
| example 29 | | | | | | | kneading |
| Comparative | 811 | 30.0 | 0.6 | 0.46 | 0.4 | 0.7 | Thick |
| example 30 | | | | | | | kneading |
| Comparative | 811 | 3.0 | 0.6 | 0.47 | 0.4 | 0.7 | Thick |
| example 31 | | | | | | | kneading |
| Comparative | 811 | 10.6 | 0.6 | 0.48 | 0.4 | 0.7 | Thick |
| example 32 | | | | | | | kneading |
| Comparative | 811 | 10.6 | 0.6 | 0.59 | 0.4 | 0.7 | Thick |
| example 33 | | | | | | | kneading |
| Comparative | 811 | 10.6 | 0.6 | 0.77 | 0.4 | 0.7 | Thick |
| example 34 | | | | | | | kneading |
| Comparative | 811 | 3.0 | 0.6 | 0.82 | 0.4 | 0.7 | Thick |
| example 35 | | | | | | | kneading |
| Comparative | 811 | 30.0 | 0.6 | 0.95 | 0.4 | 0.7 | Thick |
| example 36 | | | | | | | kneading |
| Comparative | 811 | 13.0 | 0.6 | 0.96 | 0.4 | 0.7 | Thick |
| example 37 | | | | | | | kneading |
| Comparative | 811 | 13.0 | 0.6 | 2.85 | 0.4 | 0.7 | Thick |
| example 38 | | | | | | | kneading |
| Comparative | 811 | 10.6 | 0.6 | 2.95 | 0.4 | 0.7 | Thick |
| example 39 | | | | | | | kneading |
| Comparative | 811 | 30.0 | 0.6 | 3.3 | 0.4 | 0.7 | Thick |
| example 40 | | | | | | | kneading |
| Comparative | 811 | 30.0 | 0.6 | 5.93 | 0.4 | 0.7 | Thick |
| example 41 | | | | | | | kneading |
| Comparative | 811 | 10.0 | 1 | — | 0 | 0.7 | Thick |
| example 42 | | | | | | | kneading |

TABLE 4B

| Level | rN/rL | p | n | (n × p)\hat{ }(2/3) | ACR (mΩ) |
|---|---|---|---|---|---|
| Comparative | 13.265306122 | 4.0 | 703.873386 | 199.3898396 | 26.7 |
| example 22 | | | | | |
| Comparative | 3.154761905 | 4.0 | 39.810091 | 29.37889377 | 26.8 |
| example 23 | | | | | |
| Comparative | 8.823529412 | 4.0 | 311.418685 | 115.7718852 | 28.6 |
| example 24 | | | | | |
| Comparative | 3.561643836 | 4.0 | 50.741227 | 34.53668416 | 26.9 |
| example 25 | | | | | |
| Comparative | 1.772575251 | 4.0 | 12.568092 | 13.62133153 | 31.3 |
| example 26 | | | | | |
| Comparative | 4.777070064 | 4.0 | 91.281594 | 51.08524373 | 28.4 |
| example 27 | | | | | |
| Comparative | 1.978691020 | 4.0 | 15.660873 | 15.77310879 | 31.4 |
| example 28 | | | | | |
| Comparative | 30.232558140 | 1.5 | 3656.030287 | 310.9811242 | 30.0 |
| example 29 | | | | | |
| Comparative | 65.217391304 | 1.5 | 17013.232514 | 866.7996574 | 30.2 |
| example 30 | | | | | |
| Comparative | 6.382978723 | 1.5 | 162.969670 | 39.09597329 | 28.5 |
| example 31 | | | | | |
| Comparative | 22.083333333 | 1.5 | 1950.694444 | 204.5755233 | 30.1 |
| example 32 | | | | | |
| Comparative | 17.966101695 | 1.5 | 1291.123240 | 155.3719579 | 31.0 |
| example 33 | | | | | |
| Comparative | 13.766233766 | 1.5 | 758.036768 | 108.9400793 | 29.9 |
| example 34 | | | | | |
| Comparative | 3.658536585 | 1.5 | 53.539560 | 18.61418546 | 27.8 |
| example 35 | | | | | |
| Comparative | 31.578947368 | 1.5 | 3988.919668 | 329.5826688 | 29.8 |
| example 36 | | | | | |
| Comparative | 13.541666667 | 1.5 | 733.506944 | 106.5770412 | 30.2 |
| example 37 | | | | | |
| Comparative | 4.561403509 | 1.5 | 83.225608 | 24.97845026 | 28.2 |
| example 38 | | | | | |
| Comparative | 3.593220339 | 1.5 | 51.644930 | 18.17241443 | 27.8 |
| example 39 | | | | | |
| Comparative | 9.090909091 | 1.5 | 330.578512 | 62.64848696 | 28.5 |
| example 40 | | | | | |
| Comparative | 5.059021922 | 1.5 | 102.374811 | 28.67628681 | 28.1 |
| example 41 | | | | | |
| Comparative | — | — | — | — | 31.8 |
| example 42 | | | | | |

In each of examples 1 to 11 in which the above formula (3) was satisfied, ACR was lower than 25.7 mΩ. In contrast thereto, in each of comparative examples 1 to 42 in which the above formula (3) was not satisfied, ACR was 26.6 mΩ or higher. Thus, it can be said that it is possible to suppress an increase of internal resistance by satisfying the above formula (3).

The disclosure provides a positive electrode for a non-aqueous electrolyte secondary battery and a non-aqueous electrolyte secondary battery that can suppress an increase of internal resistance, even with a positive electrode including a high-Ni-containing NCM-based positive electrode active material. Therefore, the disclosure contributes to manufacture and sale of non-aqueous electrolyte secondary batteries, and thus has industrial applicability.

According to the disclosure, even with a positive electrode including a high-Ni-containing NCM-based positive electrode active material, it is possible to obtain a positive electrode for a non-aqueous electrolyte secondary battery that can suppress an increase of internal resistance, and a non-aqueous electrolyte secondary battery using the positive electrode.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A positive electrode for a non-aqueous electrolyte secondary battery, comprising:
a positive electrode current collector; and
a positive electrode mixture layer formed on a surface of the positive electrode current collector, wherein
the positive electrode mixture layer contains:
a first positive electrode active material that is a layered compound represented by a general formula shown in a formula (1) below:
LiₐNiₓCo_{y}M1_{1-x-y}O₂(where 0<a≤1.2, 0.6≤x≤0.8, 0.1≤y≤0.2, 0.7≤x+y≤0.9) (1);
a second positive electrode active material in which a coating film made of a carbon material is formed on a surface of a phosphate compound having an olivine structure, the phosphate compound being represented by a general formula shown in a formula (2) below:
LiMn_{z}M2_{b}Fe_{1-z-b}PO₄ (where 0<z≤0.9, 0≤b≤0.1, 0<z+b<1) (2); and
an electrically conductive aid, and
the positive electrode mixture layer satisfies a formula (3) below:
$$0.8 \leq {( n \times p )}^{2 / 3} \leq 13 \qquad ( 3 )$$
where n is a theoretical minimum number of particles of the second positive electrode active material, and p is a ratio of a mass of the first positive electrode active material to a mass of the second positive electrode active material,
in the formula (1), M1 is at least one kind selected from the group consisting of Ti, Zr, Nb, W, P, Al, Mg, V, Mn, Ca, Sr, Cr, Fe, B, Ga, In, Si, Mo, Y, Sn, Cu, Ag, Ce, Pr, Ge, Bi, Ba, Er, La, Sm, Yb, Sb, Bi, S, and Zn, and
in the formula (2), M2 is at least one kind selected from the group consisting of Ni, Co, Ti, Cu, Zn, Mg, Zr, Ca, Y, Mo, Ba, Pb, Bi, La, Ce, Nd, Gd, Al, Ga, and Sr.

2. The positive electrode for a non-aqueous electrolyte secondary battery according to claim 1, wherein
the n is calculated by a formula represented by a formula (4) below:
$$n = 4 \times {( {r}_{N} / {r}_{L} )}^{2} \qquad ( 4 )$$
where r_{N} is a median diameter of secondary particles of the first positive electrode active material, and r_{L} is a median diameter of particles of the second positive electrode active material.

3. The positive electrode for a non-aqueous electrolyte secondary battery according to claim 1, wherein
the p is 4 or more and 9 or less.

4. The positive electrode for a non-aqueous electrolyte secondary battery according to claim 1, wherein
D50 representing a secondary particle size of the first positive electrode active material is 3 μm or more and 30 μm or less, and
D50 representing a secondary particle size of the second positive electrode active material is 1 μm or more and 10 μm or less.

5. A non-aqueous electrolyte secondary battery comprising:
the positive electrode for a non-aqueous electrolyte secondary battery according to claim 1;
a negative electrode;
a separator; and
a non-aqueous electrolytic solution containing lithium salt and a non-aqueous solvent.

6. The non-aqueous electrolyte secondary battery according to claim 5, wherein
the non-aqueous solvent contains dimethyl carbonate.
